(19) United States
(12) Patent Application Publication
(10) Pub. No.: US 2010/0321591 A1
(43) Pub. Date: Dec. 23, 2010

(54) Cable for Display and Television System

(75) Inventor: Takehiro ONOMATSU, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/816,673

(22) Filed: Jun. 16, 2010

(30) Foreign Application Priority Data
Jun. 17, 2009 (JP) 2009-143887

(51) Int. Cl. H01B 11/00; H04N 5/62

(52) U.S. Cl. 348/737; 174/115; 348/E05.126

(57) ABSTRACT

In this cable for a display, the respective ones of two power supply lines are arranged on both sides of an electric signal line to hold the electric signal line therebetween, and a protective coating is formed to have a flat outer shape.

### BACKGROUND OF THE INVENTION

1. Field of the Invention

The present invention relates to a cable for a display and a television system, and more particularly, it relates to a cable for a display and a television system each including an electric signal line for transmitting a signal and a power supply line for supplying power.

2. Description of the Background Art

In general, a cable for a display and a television system each including an electric signal line for transmitting a signal and a power supply line for supplying power are disclosed in each of Japanese Patent Laying-Open Nos. 9-9155 (1997), 2002-41188 and 2005-244889 and Japanese Utility Model Laying-Open No. 7-33079 (1995), for example.

The aforementioned Japanese Patent Laying-Open No. 9-9155 discloses a photoelectric composite link-type apparatus including a VTR, a TV set and a photoelectric composite cable for connecting the VTR and the TV set with each other. The photoelectric composite cable is constituted of an optical fiber for transmitting an optical signal between the VTR and the TV set and a power line for supplying power between the VTR and the TV set. The optical fiber and the power line are coated together, to be integrated into one cable having a circular outer shape.

The aforementioned Japanese Patent Laying-Open No. 2002-41188 discloses a miniature display and a display system each including a host unit provided with a control circuit such as a CPU, a signal line and a power supply line. The host unit is connected with the signal line and the power supply line, which are integrated into one cable.

The aforementioned Japanese Patent Laying-Open No. 2005-244889 discloses a television broadcast receiving system including a television receiver, a composite connector mounted on the television receiver, and an antenna control line and a power supply line connected to the composite connector. The antenna control line and the power supply line are coated together, to be integrated into one cable having a circular outer shape.

The aforementioned Japanese Utility Model Laying-Open No. 7-33079 discloses an onboard surveillance camera system including an onboard camera, a monitor display and a coaxial cable, having a circular outer shape, for connecting the onboard camera and the monitor display with each other. The coaxial cable provided on the onboard surveillance camera system is so formed as to transmit an image signal and a power signal between the onboard camera and the monitor display.

In the photoelectric composite cable described in the aforementioned Japanese Patent Laying-Open No. 9-9155, however, the optical fiber and the power line are integrated into one cable having the circular outer shape, and hence the diameter of the cable exceeds at least the sum of the diameters of the optical fiber and the power line. Therefore, the thickness of the cable itself is increased. Such a thick circular cable has a small contact area with respect to an installation surface and a large quantity of protrusion from the installation surface. Therefore, the cable is disadvantageously hard to set on an installation location (surface) such as a wall.

In relation to each of the miniature display and the display system described in the aforementioned Japanese Patent Laying-Open No. 2002-41188, no method of integrating the signal line and the power supply line is described. If the signal line and the power supply line are integrated into one cable having a circular outer shape, however, the diameter of the cable conceivably exceeds at least the sum of the diameters of the signal line and the power supply line. Therefore, the thickness of the cable itself is increased. Such a thick circular cable has a small contact area with respect to an installation surface and a large quantity of protrusion from the installation surface. Therefore, the cable is disadvantageously hard to set on an installation location (surface) such as a wall.

In the television broadcast receiving system described in aforementioned Japanese Patent Laying-Open No. 2005-244889, the antenna control line and the power supply line are integrated into one cable having the circular outer shape, and hence the diameter of the cable exceeds at least the sum of the diameters of the antenna control line and the power supply line. Therefore, the thickness of the cable itself is increased. Such a thick circular cable has a small contact area with respect to an installation surface and a large quantity of protrusion from the installation surface. Therefore, the cable is disadvantageously hard to set on an installation location (surface) such as a wall.

In the onboard surveillance camera system described in the aforementioned Japanese Utility Model Laying-Open No. 7-33079, the coaxial cable having the circular outer shape is employed and a conductor transmitting the power signal (image signal) is provided around a conductor transmitting the image signal (power signal) through an insulating film. Therefore, the thickness of the coaxial cable itself is increased due to the concentrically provided conductors. Such a thick circular cable has a small contact area with respect to an installation surface and a large quantity of protrusion from the installation surface. Therefore, the cable is disadvantageously hard to set on an installation location (surface) such as a wall.

### SUMMARY OF THE INVENTION

The present invention has been proposed in order to solve the aforementioned problems, and an object of the present invention is to provide a cable for a display easily settable on an installation location (surface) such as a wall and a television system including such a cable.

A cable for a display according to a first aspect of the present invention includes an electric signal line for transmitting an image signal consisting of an electric signal to a display, two power supply lines for supplying power to the display and a protective coating provided to cover the electric signal line and the two power supply lines, while the respective ones of the two power supply lines are arranged on both sides of the electric signal line to hold the electric signal line therebetween, and the protective coating is formed to have a flat outer shape.

In the cable for a display according to the first aspect, as hereinabove described, the protective coating has the flat outer shape, whereby the protruding height (thickness) of the cable for a display from an installation surface can be reduced and the width thereof can be increased, as compared with a case where the protective coating has a circular outer shape. When the cable for a display is set on an installation location (installation surface) such as a wall, therefore, the contact areas of the protective coating of the cable for a display and the installation location (surface) can be increased and the quantity of protrusion from the installation surface can be reduced, whereby the cable for a display can be easily set on the installation location (surface) such as a wall. When the electric signal line is constituted of a thin conductor and the two power supply lines are constituted of thick conductors, the two thick power supply lines function to reinforce the thin electric signal line, whereby the electric signal line can be prevented from deterioration caused by repetitively bending and unbending the cable for a display. Thus, the overall cable for a display can be improved in mechanical strength.

In the aforementioned cable for a display according to the first aspect, the protective coating is preferably formed to have the flat outer shape corresponding to any of a trapezoidal shape, a rectangular shape, an elliptical shape and such a shape that the thickness of a central portion corresponding to the electric signal line is smaller than the thickness of both end portions corresponding to the two power supply lines. According to this structure, the protruding height (thickness) of the cable for a display from the installation surface can be reduced and the width thereof can be increased, as compared with a case where the protective coating has a circular outer shape, for example. When the cable for a display is set on the installation location (installation surface) such as a wall, therefore, the contact areas of the protective coating of the cable for a display and the installation location (surface) can be more increased and the quantity of protrusion from the installation surface can be reduced, whereby the cable for a display can be easily set on the installation location (surface) such as a wall.

In the aforementioned cable for a display according to the first aspect, the electric signal line preferably includes a plurality of electric signal conductors, the protective coating preferably includes a first protective coating covering each of the plurality of electric signal conductors and a second protective coating covering all of the plurality of electric signal conductors each covered with the first protective coating and the two power supply lines, and the second protective coating is preferably formed to have the flat outer shape. Even if either the first protective coating or the second protective coating covering the electric signal conductors is broken, the electric signal conductors can be protected with either the unbroken second protective coating or the unbroken first protective coating according to this structure.

In the aforementioned cable for a display according to the first aspect, the protective coating preferably directly covers the two power supply lines and the electric signal line together, and is preferably formed to have the flat outer shape. According to this structure, the protective coating directly covers the two power supply lines and the electric signal line together, whereby the structure of the cable for a display can be simplified as compared with a case where a plurality of protective coatings cover the two power supply lines and the electric signal line together.

In the aforementioned cable for a display including the plurality of electric signal conductors, each of the two power supply lines preferably has a sectional area larger than the sectional area of each of the plurality of electric signal conductors. According to this structure, the two power supply lines are thicker than the electric signal conductors, whereby the overall cable for a display can be further improved in mechanical strength against bending and unbending.

In the aforementioned cable for a display according to the first aspect, the electric signal line arranged to be held between the respective ones of the two power supply lines preferably includes a first LAN cable or an HDMI cable. According to this structure, the cable for a display having a flat outer shape can be easily formed with the first LAN cable or the HDMI cable.

In this case, the electric signal line arranged to be held between the respective ones of the two power supply lines is preferably the first LAN cable. The term “first LAN cable” is directed to a wide concept including not only a general LAN cable but also a wire corresponding to the LAN cable standard. When the first LAN cable is employed, failure in the image signal can be reduced according to this structure by transmitting the image signal in a state converted to a high-frequency signal also when the length of the cable itself is increased, for example.

In the aforementioned cable for a display including the first LAN cable, a LAN port for connecting the first LAN cable with a second LAN cable different from the first LAN cable is preferably provided in the vicinity of an end portion of the first LAN cable arranged to be held between the respective ones of the two power supply lines. According to this structure, the second LAN cable different from the first LAN cable can be easily connected to the first LAN cable at the LAN port even if the length of the first LAN cable is reduced in response to the length of the power supply lines, whereby only the LAN cables can be easily lengthened.

In the aforementioned cable for a display according to the first aspect, the two power supply lines and the electric signal line are preferably arranged to diverge, and the cable for a display preferably further includes a noise eliminating member provided in the vicinity of the portion where the two power supply lines and the electric signal line diverge. According to this structure, noise generated from the power supply lines or the electric signal line integrated into the cable for a display can be eliminated, for example, whereby the power supply lines and the electric signal line integrated into the cable for a display can be inhibited from influencing each other.

In the aforementioned cable for a display according to the first aspect, the protective coating having the flat outer shape is preferably semitransparent. According to this structure, the protective coating can be rendered inconspicuous as compared with a case where the same is colored.

In the aforementioned cable for a display according to the first aspect, the surface of the protective coating having the flat outer shape is preferably so satin-finished that the protective coating is easily bondable. According to this structure, the cable for a display can be easily bonded to a wall surface when the same is arranged on the installation location such as the wall surface, for example.

A television system according to a second aspect of the present invention includes a television set including a display portion displaying an image corresponding to an image signal consisting of an electric signal, an external input unit for transmitting the image signal for displaying the image on the display portion and a cable for a television set including an electric signal line for transmitting the image signal consisting of the electric signal to the television set, two power supply lines for supplying power to the television set and a protective coating provided to cover the electric signal line and the two power supply lines, while the respective ones of the two power supply lines included in the cable for a television set are arranged on both sides of the electric signal line to hold the electric signal line therebetween, the protective coating is formed to have a flat outer shape, and the image signal from the external input unit is transmitted to the television set through the electric signal line of the cable for a television set.

In the television system according to the second aspect, as hereinabove described, the respective ones of the two power supply lines of the cable for a television set are arranged on both sides of the electric signal line to hold the electric signal line therebetween so that the protective coating has the flat outer shape, whereby the protruding height (thickness) of the cable for a television set from an installation surface can be reduced and the width thereof can be increased, as compared with a case where the protective coating has a circular outer shape. When the cable for a television set is set on an installation location (installation surface) such as a wall, therefore, the contact areas of the protective coating of the cable for a television set and the installation location (surface) can be increased and the quantity of protrusion from the installation surface can be reduced, whereby the cable for a television set can be easily set on the installation location (surface) such as a wall. When the electric signal line is constituted of a thin conductor and the two power supply lines are constituted of thick conductors, the two thick power supply lines function to reinforce the thin electric signal line, whereby the electric signal line can be prevented from deterioration caused by repetitively bending and unbending the cable for a television set. Thus, the overall cable for a television set can be improved in mechanical strength. Further, the image signal can be easily and reliably transferred between the external input unit and the television set with the cable for a television set having the flat outer shape.

In the aforementioned television system according to the second aspect, the protective coating of the cable for a television set is preferably formed to have the flat outer shape corresponding to any of a trapezoidal shape, a rectangular shape, an elliptical shape and such a shape that the thickness of a central portion corresponding to the electric signal line is smaller than the thickness of both end portions corresponding to the two power supply lines. According to this structure, the image signal can be easily transferred between the external input unit and the television set through the cable for a television set having the flat outer shape corresponding to any of the trapezoidal shape, the rectangular shape, the elliptical shape and the shape in which the thickness of the central portion corresponding to the electric signal is smaller than the thickness of both end portions corresponding to the two power supply lines.

In the aforementioned television system according to the second aspect, the electric signal line of the cable for a television set preferably includes a plurality of electric signal conductors, the protective coating of the cable for a television set preferably includes a first protective coating covering each of the plurality of electric signal conductors and a second protective coating covering all of the plurality of electric signal conductors each covered with the first protective coating and the two power supply lines, and the second protective coating is preferably formed to have the flat outer shape. According to this structure, the image signal can be easily transferred between the external input unit and the television set through the cable for a television set including the second protective coating having the flat outer shape.

In the aforementioned television system according to the second aspect, the protective coating of the cable for a television set preferably directly covers the two power supply lines and the electric signal line together, and is preferably formed to have the flat outer shape. According to this structure, the image signal can be easily transferred between the external input unit and the television set through the cable for a television set including the protective coating directly covering the two power supply lines and the electric signal line together and having the flat outer shape.

In the aforementioned television system according to the second aspect, each of the two power supply lines of the cable for a television set preferably has a sectional area larger than the sectional area of each of the plurality of electric signal conductors. According to this structure, the image signal can be easily transferred between the external input unit and the television set through the cable for a television in which each of the two power supply lines has the sectional area larger than that of each of the plurality of electric signal conductors.

In the aforementioned television system according to the second aspect, the cable for a television set preferably includes a first LAN cable or an HDMI cable, and the image signal from the external input unit is preferably transmitted to the television set through the first LAN cable or the HDMI cable. According to this structure, the cable for a television set having a flat outer shape is easily formed with the first LAN cable or the HDMI cable, and the image signal can be easily transferred between the external input unit and the television set.

In this case, the image signal from the external input unit is preferably transmitted to the television set through the first LAN cable. According to this structure, failure in data can be reduced in the LAN cable (first LAN cable) regardless of the length thereof by transmitting the image signal in a state converted to a high-frequency signal, for example, whereby a cable for a television set having a large length can be formed and the image signal can be reliably transferred between the external input unit and the television set.

The aforementioned television system including the first LAN cable preferably further includes a second LAN cable mounted on the external input unit, a LAN port for connecting the first LAN cable with the second LAN cable different from the first LAN cable is preferably provided in the vicinity of an end portion of the first LAN cable arranged to be held between the respective ones of the two power supply lines, and the image signal from the external input unit is preferably transmitted to the television set through the second LAN cable mounted on the external input unit, the LAN port and the first LAN cable. According to this structure, the second LAN cable different from the first LAN cable can be easily connected to the first LAN cable at the LAN port even if the length of the first LAN cable is reduced in response to the length of the power supply lines, whereby only the LAN cables can be easily lengthened.

In the aforementioned television system according to the second aspect, the protective coating, having the flat outer shape, of the cable for a television set is preferably semitransparent. According to this structure, the image signal can be easily transferred between the external input unit and the television set through the cable for a television set including the protective coating inconspicuous as compared with a colored protective coating.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically illustrates the structure of a television system according to a first embodiment of the present invention;

FIG. 2 is a block diagram showing the structure of the television system according to the first embodiment of the present invention;

FIG. 3 is a sectional view of a cable for a display having a trapezoidal outer shape according to the first embodiment of the present invention;

FIG. 4 illustrates satin finishing on the surface of a second coating of the cable for a display according to the first embodiment of the present invention;

FIG. 5 is a sectional view of a cable for a display having a rectangular outer shape according to a second embodiment of the present invention;

FIG. 6 is a sectional view of a cable for a display having an elliptical outer shape according to a third embodiment of the present invention;

FIG. 7 is a sectional view of a cable for a display, having such an outer shape that the thickness of a central portion corresponding to an electric signal line is smaller than that of both end portions corresponding to two power supply lines, according to a fourth embodiment of the present invention; and

FIG. 8 is a sectional view of a cable for a display having a rectangular outer shape according to a modification of the present invention.

### DESCRIPTION OF THE PREFERRED EMBODIMENTS

Embodiments of the present invention are now described with reference to the drawings.

### First Embodiment

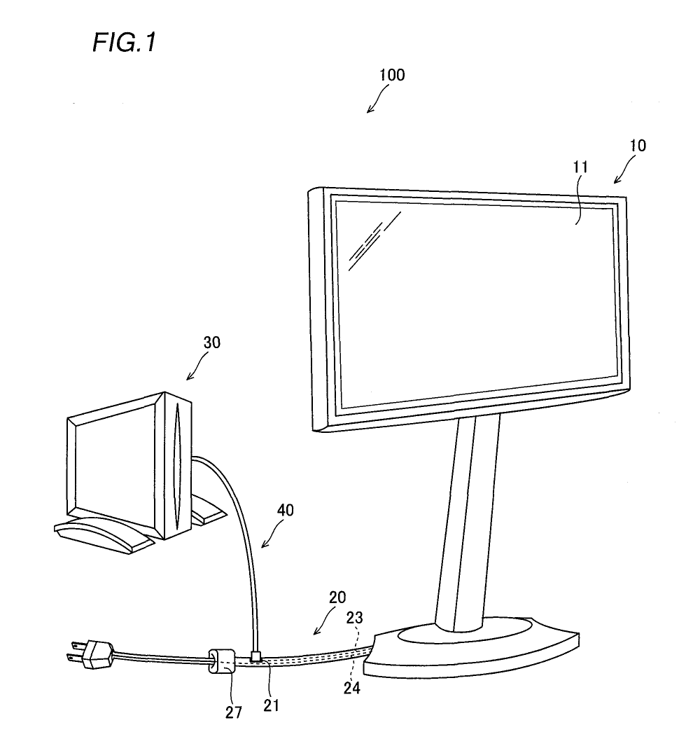

The structure of a television system 100 according to a first embodiment of the present invention is described with reference to FIGS. 1 to 4.

The television system 100 according to the first embodiment of the present invention is mainly constituted of a liquid crystal television 10 including a display portion 11 displaying an image corresponding to an image signal, a liquid crystal television cable 20 mounted on the liquid crystal television 10, an external input unit 30 consisting of a BD (Blu-ray Disc) player or a tuner unit for transmitting the image signal for displaying the image on the display portion 11 and a LAN (Local Area Network) cable 40 mounted on the external input unit 30, as shown in FIG. 1. The LAN cable 40 is an example of the “second LAN cable” in the present invention. The liquid crystal television 10 is an example of the “display” or the “television set” in the present invention, and the liquid crystal television cable 20 is an example of the “cable for a display” or the “cable for a television set” in the present invention. According to the first embodiment, a LAN cable of the category 5 (CAT 5) used for a high-speed LAN of 10Base-T, 100Base-TX or ATM (asynchronous transfer mode) is employed as an exemplary LAN cable.

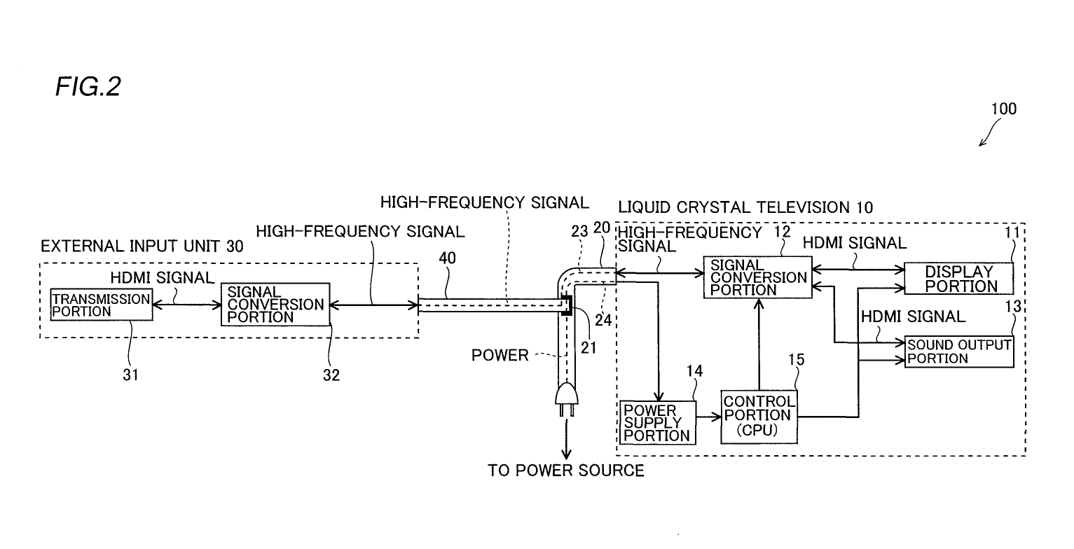

As shown in FIG. 2, the liquid crystal television 10 includes a display portion 11, a signal conversion portion 12, a sound output portion 13, a power supply portion 14 and a control portion (CPU) 15. The signal conversion portion 12 is connected with the display portion 11, the sound output portion 13 and the control portion 15. The control portion 15 is connected with the power supply portion 14.

According to the first embodiment, a LAN port 21 for connecting a LAN cable 23, described later, included in the liquid crystal television cable 20 with the LAN cable 40 is provided in the vicinity of an end portion of the LAN cable 23, as shown in FIG. 1. The LAN cable 23 is an example of the “electric signal line” or the “first LAN cable” in the present invention. The term “LAN cable 23” is directed to a wide concept including not only a general LAN cable but also a wire corresponding to the LAN cable standard. The LAN port 21 is constituted of a connecting terminal such as an RJ45 modular jack.

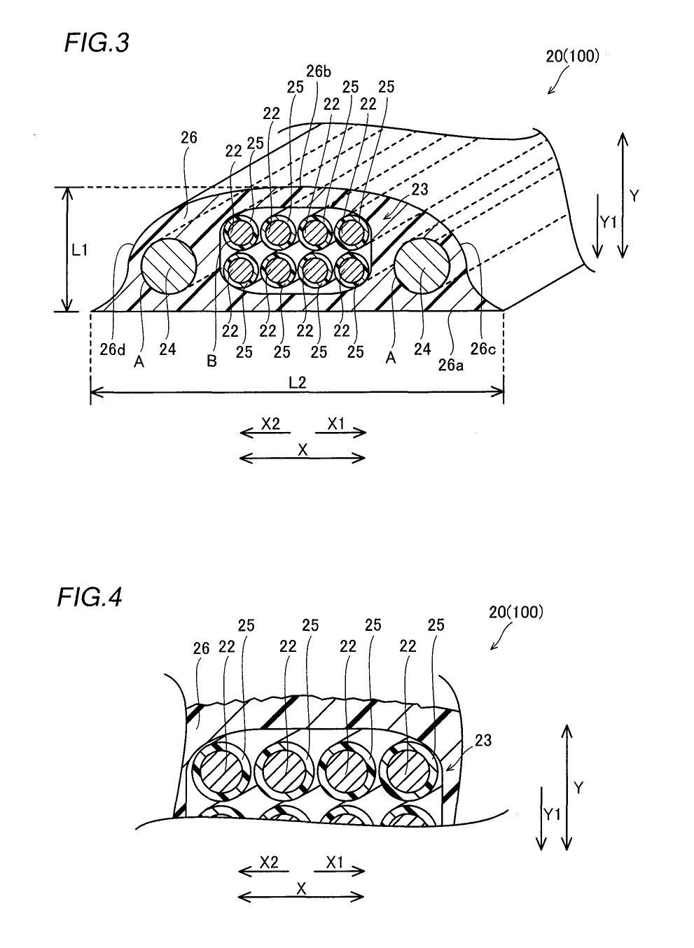

According to the first embodiment, the liquid crystal television cable 20 includes the LAN cable 23 including eight electric signal conductors 22 for transmitting the image signal consisting of an electric signal to the liquid crystal television 10 (see FIG. 1) and two power supply lines 24 for supplying power to the liquid crystal television 10, as shown in FIG. 3. The eight electric signal conductors 22 of the LAN cable 23 are stacked in two rows in a direction Y.

According to the first embodiment, the liquid crystal television cable 20 is so formed that the respective ones of the two power supply lines 24 are arranged on both sides of the LAN cable 23 to hold the LAN cable 23 therebetween. More specifically, the LAN cable 23 is arranged in the vicinity of a central portion of the liquid crystal television cable 20. The power supply lines 24 are arranged on both sides of the LAN cable 23 along arrows X1 and X2 respectively.

According to the first embodiment, the liquid crystal television cable 20 includes first protective coatings 25 of resin individually covering the eight electric signal conductors 22 respectively and a second protective coating 26 of resin entirely covering the eight electric signal conductors 22 covered with the first protective coatings 25 and the two power supply lines 24. The first and second protective coatings 25 and 26 form a double-structure protective coating covering the electric signal conductors 22, whereby the first protective coatings 25 can slide with respect to the second protective coating 26 when the liquid crystal television cable 20 is bent.

The second protective coating 26 of the liquid crystal television cable 20 is so formed that the length (cable thickness) L1 in the direction Y is smaller than the length (cable width) L2 in a direction X when the liquid crystal television cable 20 is set on an installation location (surface) along arrow Y1. According to the first embodiment, further, the sectional area A and the outer diameter of each of the two power supply lines 24 are larger than the sectional area B and the outer diameter of each of the eight electric signal conductors 22 of the LAN cable 23.

According to the first embodiment, the second protective coating 26 of the liquid crystal television cable 20 is formed to have such an outer shape, close to a substantially trapezoidal shape (flat shape), that the cable width (L2) of the liquid crystal television cable 20 is larger than the cable thickness (L1) thereof. In other words, the base (lower surface) 26a of the second protective coating 26 is in the form of a planar surface. A central portion of the upper surface 26b of the second protective coating 26 is also in the form of a planar surface. Side surfaces 26c and 26d of the second protective coating 26 are inclined to spread the width of the second protective coating 26 downward. Boundaries between the upper surface 26b and the side surfaces 26c and 26d of the second protective coating 26 are rounded. Base portions of the side surfaces 26c and 26d of the second protective coating 26 closer to the base (lower surface) 26a have an angle of inclination (smaller angle of inclination with respect to the base 26a) for more spreading the width of the second protective coating 26 than the angle of inclination of central portions of the side surfaces 26c and 26d with respect to the base (lower surface) 26a.

According to the first embodiment, a noise eliminating member 27 consisting of a ferrite core or the like is provided in the vicinity of a portion where the two power supply lines 24 and the LAN cable 23 diverge, as shown in FIG. 1.

As shown in FIG. 3, the first and second protective coatings 25 and 26 of the liquid crystal television cable 20 are made of semitransparent resin, so that the color (metallic color such as copper red) of the LAN cable 23 and the two power supply lines 24 is visible from outside the liquid crystal television cable 20. The term “semitransparent resin” is directed to a wide concept including not only clear resin but also colored semitransparent resin such as semitransparent resin colored blue or brown. As shown in FIG. 4, the surface of the second protective coating 26 of the liquid crystal television cable 20 is satin-finished (matted), so that the liquid crystal television cable 20 is easily bondable to the installation location such as a wall surface. The surface of the second protective coating 26 is so satin-finished that a tape for execution or the like can be easily applied thereto. When the liquid crystal television cable 20 is arranged on the installation location, a tape of a color similar to that of the installation location may be applied to the surface of the semitransparent second protective coating 26, to mask the same. Alternatively, the liquid crystal television cable 20 may be applied to the installation location through a double-faced adhesive tape bonded to the side of the liquid crystal television cable 20 closer to the installation location (surface). Further alternatively, the liquid crystal television cable 20 may be fixed to the wall surface with a clip for execution or the like.

According to the first embodiment, the external input unit 30 includes a′transmission portion 31 capable of transmitting (outputting) an HDMI signal corresponding to the HDMI (High-Definition Multimedia Interface) standard and a signal conversion portion 32 capable of converting the HDMI signal received from the transmission portion 31 to a prescribed high-frequency signal and outputting the converted high-frequency signal to the LAN cable 40, as shown in FIG. 2. The converted high-frequency signal is transmitted to the liquid crystal television 10 through the LAN cable 40, the LAN port 21 and the LAN cable 23.

The high-frequency signal transmitted from the LAN cable 40 is input in the signal conversion portion 12 of the liquid crystal television 10. The high-frequency signal input in the signal conversion portion 12 is converted to an HDMI signal corresponding to the HDMI signal, and the converted HDMI signal is output to the display portion 11 and the sound output portion 13. The display portion 11 displays an image based on the HDMI signal, while the sound output portion 13 outputs a sound based on the HDMI signal.

Power supplied from the two power supply lines 24 of the liquid crystal television cable 20 is supplied to the power supply portion 14. The power supplied to the power supply portion 14 is further supplied to the control portion 15.

According to the first embodiment, as hereinabove described, the second protective coating 26 has the substantially trapezoidal (flat) outer shape, whereby the protruding height (cable thickness L1) of the second protective coating 26 from the installation surface can be reduced and the cable width L2 of the second protective coating 26 can be increased, as compared with a case where the second protective coating 26 has a circular outer shape. When the liquid crystal television cable 20 is set on the installation location (installation surface) such as a wall, therefore, the contact areas of the second protective coating 26 and the installation location (surface) can be increased and the quantity of protrusion from the installation surface can be reduced, whereby the liquid crystal television cable 20 can be easily set on the installation location (surface) such as a wall. When the LAN cable 23 is constituted of a thin conductor and the two power supply lines 24 are constituted of thick conductors, the two thick power supply lines 24 function to reinforce the thin LAN cable 23, whereby the LAN cable 23 can be prevented from deterioration caused by repetitively bending and unbending the liquid crystal television cable 20. Thus, the overall liquid crystal television cable 20 can be improved in mechanical strength.

According to the first embodiment, as hereinabove described, the second protective coating 26 has the substantially trapezoidal outer shape, whereby the protruding height (cable thickness L1) of the second protective coating 26 from the installation surface can be reduced and the cable width L2 thereof can be increased, as compared with a case where the second protective coating 26 has a circular outer shape, for example. When the liquid crystal television cable 20 is set on the installation location (installation surface) such as a wall, therefore, the contact areas of the second protective coating 26 of the liquid crystal television cable 20 and the installation location (surface) can be reduced and the quantity of protrusion from the installation surface can be reduced, whereby the liquid crystal television cable 20 can be easily set on the installation location (surface) such as a wall.

According to the first embodiment, as hereinabove described, the protective coating includes the first protective coatings 25 individually covering the eight electric signal conductors 22 respectively and the second protective coating 26 entirely covering the eight electric signal conductors 22 covered with the first protective coatings 25 and the two power supply lines 24 while the second protective coating 26 is formed to have the flat outer shape. When either the first protective coatings 25 or the second protective coating 26 covering the electric signal conductors 22 is broken, therefore, the electric signal conductors 22 can be protected with either the unbroken second protective coating 26 or the unbroken first protective coatings 25.

According to the first embodiment, as hereinabove described, each of the two power supply lines 24 has the sectional area larger than that of each of the eight electric signal conductors 22 so that the two power supply lines 24 are thicker than the electric signal conductors 22, whereby the overall liquid crystal television cable 20 can be further improved in mechanical strength against bending and unbending.

According to the first embodiment, as hereinabove described, the LAN cable 23 includes the eight electric signal conductors 22 arranged to be held between the respective ones of the two power supply lines 24, whereby failure in the image signal can be reduced by transmitting the same in the state converted to the high-frequency signal when the LAN cable 23 is employed, for example, even if the length of the cable itself is increased.

According to the first embodiment, as hereinabove described, the LAN port 21 for connecting the LAN cable 23 with the LAN cable 40 different from the LAN cable 23 is provided in the vicinity of the end portion of the LAN cable 23 arranged to be held between the two power supply lines 24 so that the LAN cable 40 can be easily connected to the LAN cable 23 at the LAN port 21 even if the length of the LAN cable 23 is reduced in response to the length of the two power supply lines 24, whereby only the LAN cables 23 and 40 can be easily lengthened.

According to the first embodiment, as hereinabove described, the television system 100 includes the noise eliminating member 27 provided in the vicinity of the portion where the two power supply lines 24 and the LAN cable 23 diverge so that noise generated from the power supply lines 24 or the LAN cable 23 integrated into the liquid crystal television cable 20 can be eliminated, for example, whereby the power supply lines 24 and the LAN cable 23 integrated into the liquid crystal television cable 20 can be inhibited from influencing each other.

According to the first embodiment, as hereinabove described, the second protective coating 26 having the substantially trapezoidal (flat) outer shape is semitransparent, whereby the second protective coating 26 can be rendered inconspicuous as compared with a case where the same is colored.

According to the first embodiment, as hereinabove described, the surface of the second protective coating 26 having the substantially trapezoidal (flat) outer shape is so satin-finished that the second protective coating 26 is easily bondable, whereby the liquid crystal television cable 20 can be easily bonded to a wall surface when the same is set on the installation location such as the wall surface, for example.

According to the first embodiment, as hereinabove described, the respective ones of the two power supply lines 24 of the liquid crystal television cable 20 are arranged on both sides of the LAN cable 23 to hold the same therebetween, whereby the image signal can be easily transferred between the external input unit 30 and the liquid crystal television 10 through the liquid crystal television cable 20 having the substantially trapezoidal (flat) outer shape.

According to the first embodiment, as hereinabove described, the television system 100 is so formed that the image signal from the external input unit 30 is transmitted to the liquid crystal television 10 through the LAN cable 40 mounted on the external input unit 30, the LAN port 21 and the LAN cable 23 so that the LAN cable 23 and the LAN cable 40 mounted on the external input unit 30 are easily connected with each other, whereby the image signal can be reliably transferred between the external input unit 30 and the liquid crystal television 10.

### Second Embodiment

The structure of a television system 101 according to a second embodiment of the present invention is now described with reference to FIG. 5. In the television system 101 according to the second embodiment, a second protective coating 126 of a liquid crystal television cable 120 has a rectangular outer shape, dissimilarly to the first embodiment in which the second protective coating 26 of the liquid crystal television cable 20 has the substantially trapezoidal outer shape (shape close to a trapezoidal shape). The liquid crystal television cable 120 is an example of the “cable for a display” or the “cable for a television set” in the present invention.

The second protective coating 126 of the liquid crystal television cable 120 according to the second embodiment is formed to have a substantially rectangular (flat) outer shape. More specifically, the second protective coating 126 of the liquid crystal television cable 120 has such a horizontally elongated rectangular shape that the length (cable thickness) L3 in a direction Y is smaller than the length (cable width) L4 in a direction X when the liquid crystal television cable 120 is set on an installation location (surface) along arrow Y1.

The remaining structure of the second embodiment is similar to that of the aforementioned first embodiment.

According to the second embodiment, as hereinabove described, the second protective coating 126 is formed to have the rectangular flat outer shape, whereby the protruding height (cable thickness L3) of the second protective coating 126 from the installation surface can be reduced and the cable width L3 thereof can be increased, as compared with a case where the second protective coating 126 is formed to have a circular outer shape, for example. When the liquid crystal television cable 120 is arranged on the installation location (installation surface) such as a wall, therefore, the contact areas of the second protective coating 126 of the liquid crystal television cable 120 and the installation location (surface) can be increased and the quantity of protrusion from the installation surface can be reduced, whereby the liquid crystal television cable 120 can be easily set on the installation location (surface) such as a wall.

The remaining effects of the second embodiment are similar to those of the aforementioned first embodiment.

### Third Embodiment

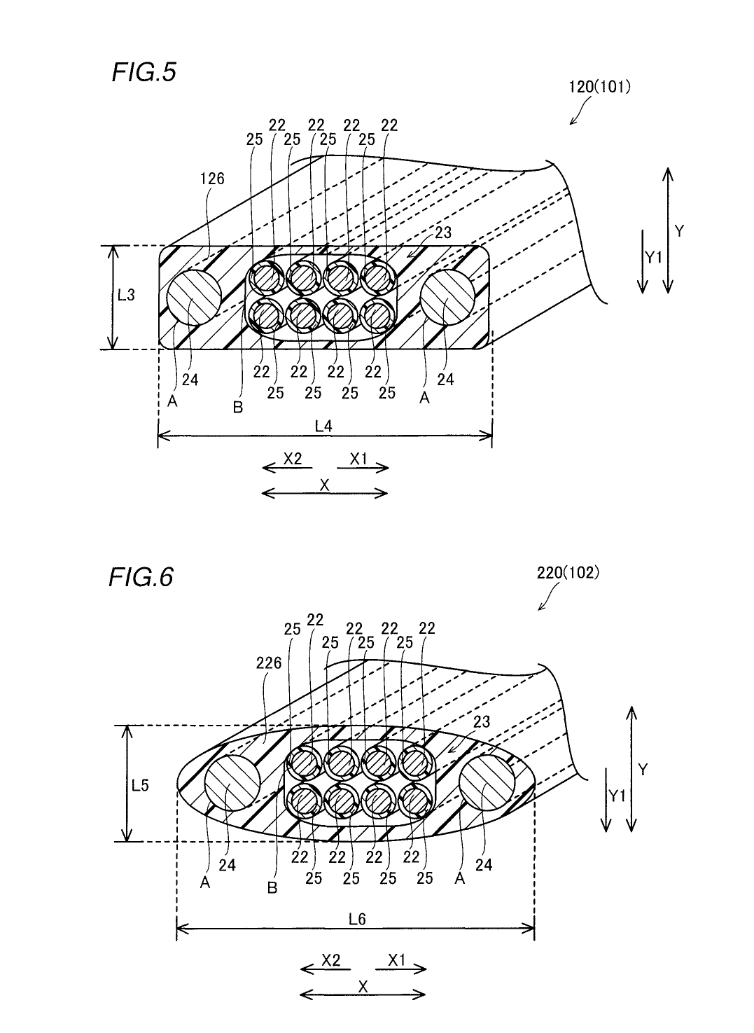

The structure of a television system 102 according to a third embodiment of the present invention is now described with reference to FIG. 6. In the television system 102 according to the third embodiment, a second protective coating 226 of a liquid crystal television cable 220 has a horizontally elongated elliptical outer shape, dissimilarly to the first embodiment in which the second protective coating 26 of the liquid crystal television cable 20 has the substantially trapezoidal outer shape (shape close to a trapezoidal shape). The liquid crystal television cable 220 is an example of the “cable for a display” or the “cable for a television set” in the present invention.

The second protective coating 226 of the liquid crystal television cable 220 according to the third embodiment is formed to have the elliptical (flat) outer shape. More specifically, the second protective coating 226 of the liquid crystal television cable 220 is so formed that the length (cable thickness) L5 in a direction Y is smaller than the length (cable width) L6 in a direction X when the liquid crystal television cable 220 is set on an installation location (surface) along arrow Y1.

The remaining structure of the third embodiment is similar to that of the aforementioned first embodiment.

According to the third embodiment, as hereinabove described, the second protective coating 226 is formed to have the elliptical outer shape, whereby the protruding height (cable thickness L5) of the second protective coating 226 from the installation surface can be reduced and the cable width L6 thereof can be increased, as compared with a case where the second protective coating 226 is formed to have a circular outer shape, for example. When the liquid crystal television cable 220 is arranged on the installation location (installation surface) such as a wall, therefore, the contact areas of the second protective coating 226 of the liquid crystal television cable 220 and the installation location (surface) can be increased and the quantity of protrusion from the installation surface can be reduced, whereby the liquid crystal television cable 220 can be easily set on the installation location (surface) such as a wall.

The remaining effects of the third embodiment are similar to those of the aforementioned first embodiment.

### Fourth Embodiment

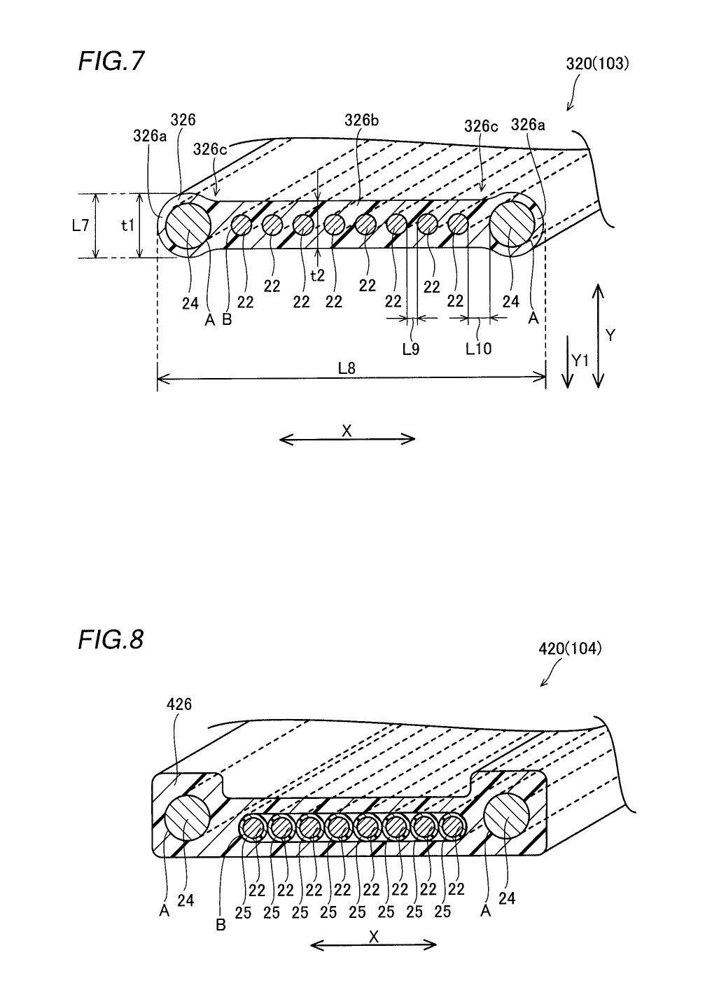

The structure of a television system 103 according to a fourth embodiment of the present invention is now described with reference to FIG. 7. In the television system 103 according to the fourth embodiment, a protective coating 326 of a liquid crystal television cable 320 has such a flat outer shape that the thickness t2 of a central portion 326b corresponding to eight electric signal lines 22 is smaller than the thickness t1 of both end portions 226a corresponding to two power supply lines 24, dissimilarly to the first embodiment in which the second protective coating 26 of the liquid crystal television cable 20 has the substantially trapezoidal outer shape (shape close to a trapezoidal shape). The liquid crystal television cable 320 is an example of the “cable for a display” or the “cable for a television set” in the present invention.

The two power supply lines 24 and the eight electric signal lines 22 of the liquid crystal television cable 320 according to the fourth embodiment are aligned in a direction X. The surfaces of the two power supply lines 24 are plated with a metal, to be colored.

According to the fourth embodiment, the protective coating 326 integrally directly covers the two power supply lines 24 and the eight electric signal lines 22 together. The protective coating 326 is made of transparent plastic (vinyl resin). The term “transparent plastic” is directed to a wide concept including semitransparent plastic and colored semitransparent plastic.

According to the fourth embodiment, the protective coating 326 of the liquid crystal television cable 320 is so formed that the thickness t2 of the central portion 326b corresponding to the electric signal lines 22 in the direction Y is smaller than the thickness t1 of the end portions 326a corresponding to the two electric supply lines 24 in the direction Y. Further, the protective coating 326 of the liquid crystal television cable 320 is formed have such a flat shape that the length (cable thickness) L7 in the direction Y is smaller than the length (cable width) L8 in the direction X when the liquid crystal television cable 320 is set on an installation location (surface) along arrow Y1.

The distance L9 between each pair of electric signal lines 22 of the liquid crystal television cable 320 is smaller than the distance L10 between each of the outermost electric signal lines 22 included in the eight electric signal lines 22 and each power supply line 24. Further, portions 326c of the protective coating 326 corresponding to the boundaries between the power supply lines 24 and the outermost electric signal lines 22 are formed to be smoothly inclined.

Each of the end portions 326a of the protective coating 326 of the liquid crystal television cable 320 corresponding to the power supply lines 24 has a substantially circular outer shape reflecting the outer shape of each power supply line 24. The central portion 326b of the protective coating 326 of the liquid crystal television cable 320 corresponding to the eight electric signal lines 22 of the protective coating 326 is in the form of a substantially planar surface.

The remaining structure of the fourth embodiment is similar to that of the aforementioned first embodiment.

According to the fourth embodiment, as hereinabove described, the protective coating 326 is so formed that the thickness t2 of the central portion 326b corresponding to the electric signal lines 22 is smaller than the thickness t1 of the end portions 326a corresponding to the two power supply lines 24, whereby the protruding height (cable thickness L7) of the protective coating 326 from the installation surface can be reduced and the cable width L8 of the protective coating 326 can be increased, as compared with a case where the protective coating 326 is formed to have a circular outer shape, for example. When the liquid crystal television cable 320 is set on the installation location (installation surface) such as a wall, therefore, the contact areas of the protective coating 326 of the liquid crystal television cable 320 and the installation location (surface) can be increased and the quantity of protrusion from the installation surface can be reduced, whereby the liquid crystal television cable 320 can be easily set on the installation location (surface) such as a wall.

According to the fourth embodiment, as hereinabove described, the protective coating 326 directly covers the two power supply lines 24 and the electric signal lines 22 together and has the flat outer shape so that the single protective coating 326 directly covers the two supply lines 24 and the electric signal lines 22 together, whereby the structure of the liquid crystal television cable 320 can be simplified as compared with a case where a plurality of protective coatings cover the two supply lines 24 and the electric signal lines 22 together.

The remaining effects of the fourth embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention is applied to the liquid crystal television employed as an exemplary television set in each of the aforementioned first to fourth embodiments, the present invention is not restricted to this, but may alternatively be applied to another television set, other than the liquid crystal television, such as a CRT television, a monitor of a PC (personal computer) having a televisional function or a plasma television.

While the liquid crystal television cable is employed as an exemplary cable for a display in each of the aforementioned first to fourth embodiments, the present invention is not restricted to this, but is also applicable to a display other than the liquid crystal television.

While the second protective coating is formed to have the flat outer shape corresponding to any of the substantially trapezoidal shape (shape close to a trapezoidal shape), the rectangular shape and the elliptical shape in each of the aforementioned first to third embodiments, the present invention is not restricted to this, but the second protective coating may alternatively have an outer shape other than the above, so far as the outer shape is flat.

While the LAN cable of the category 5 (CAT 5) used for a high-speed LAN of 10Base-T, 100Base-TX or ATM (asynchronous transfer mode) is employed as an exemplary LAN cable in each of the aforementioned first to fourth embodiments, the present invention is not restricted to this, but is also applicable to a LAN cable other than that of the category 5 (CAT 5) so far as the same can transmit an electric signal from the external input unit to the liquid crystal television.

While the eight electric signal conductors (lines) are employed as those included in an exemplary first LAN cable in each of the aforementioned first to fourth embodiments, the present invention is not restricted to this, but the number of the electric signal conductors (lines) may be other than eight.

While the electric signal conductors of the first LAN cable are stacked in two rows in each of the aforementioned first to third embodiments, the present invention is not restricted to this, but electric signal conductors 22 may alternatively be aligned in a direction X to be adjacent to each other, as in a liquid crystal television cable 420 of a television system 104 according to a modification of the present invention shown in FIG. 8. Thus, a second protective coating 426 of the liquid crystal television cable 420 can be formed to have a flatter outer shape having a smaller cable thickness as compared with each of the second protective coatings of the liquid crystal television cables according to the aforementioned first to third embodiments. Further alternatively, the electric signal conductors 22 may be arranged in three or more rows, so far as the second protective coating has a flat outer shape.

While the RJ45 modular jack is employed as an exemplary LAN port in each of the aforementioned first to fourth embodiments, the present invention is not restricted to this, but a connecting terminal other than the RJ45 modular jack may alternatively be applied.

While the semitransparent second protective coating is employed in each of the aforementioned first to third embodiments, the present invention is not restricted to this, but the second protective coating may alternatively have a color identical to that of the installation location (surface) on which the liquid crystal television is arranged.

While the LAN cable is employed as an exemplary electric signal line in each of the aforementioned first to fourth embodiments, the present invention is not restricted to this, but an HDMI cable corresponding to the HDMI standard may alternatively be employed. In this case, the signal conversion portions provided on the external input unit and the liquid crystal television respectively are omitted. Further, an HDMI signal output from the transmission portion of the external input unit is transmitted to the liquid crystal television through the HDMI cable.

What is claimed is:

1. A cable for a display comprising:
an electric signal line for transmitting an image signal consisting of an electric signal to a display;
two power supply lines for supplying power to said display; and
a protective coating provided to cover said electric signal line and said two power supply lines, wherein
the respective ones of said two power supply lines are arranged on both sides of said electric signal line to hold said electric signal line therebetween, and said protective coating is formed to have a flat outer shape.

2. The cable for a display according to claim 1, wherein
said protective coating is formed to have said flat outer shape corresponding to any of a trapezoidal shape, a rectangular shape, an elliptical shape and such a shape that the thickness of a central portion corresponding to said electric signal line is smaller than the thickness of both end portions corresponding to said two power supply lines.

3. The cable for a display according to claim 1, wherein
said electric signal line includes a plurality of electric signal conductors,
said protective coating includes a first protective coating covering each of said plurality of electric signal conductors and a second protective coating covering all of said plurality of electric signal conductors each covered with said first protective coating and said two power supply lines, and
said second protective coating is formed to have said flat outer shape.

4. The cable for a display according to claim 1, wherein
said protective coating directly covers said two power supply lines and said electric signal line together, and is formed to have said flat outer shape.

5. The cable for a display according to claim 3, wherein
each of said two power supply lines has a sectional area larger than the sectional area of each of said plurality of electric signal conductors.

6. The cable for a display according to claim 1, wherein
said electric signal line arranged to be held between the respective ones of said two power supply lines includes a first LAN cable or an HDMI cable.

7. The cable for a display according to claim 6, wherein
said electric signal line arranged to be held between the respective ones of said two power supply lines is said first LAN cable.

8. The cable for a display according to claim 7, wherein
a LAN port for connecting said first LAN cable with a second LAN cable different from said first LAN cable is provided in the vicinity of an end portion of said first LAN cable arranged to be held between the respective ones of said two power supply lines.

9. The cable for a display according to claim 1, wherein
said two power supply lines and said electric signal line are arranged to diverge, and
the cable for a display further comprises a noise eliminating member provided in the vicinity of the portion where said two power supply lines and said electric signal line diverge.

10. The cable for a display according to claim 1, wherein
said protective coating having said flat outer shape is semitransparent.

11. The cable for a display according to claim 1, wherein
the surface of said protective coating having said flat outer shape is so satin-finished that said protective coating is easily bondable.

12. A television system comprising:
a television set including a display portion displaying an image corresponding to an image signal consisting of an electric signal;
an external input unit for transmitting said image signal for displaying said image on said display portion; and
a cable for a television set including an electric signal line for transmitting said image signal consisting of said electric signal to said television set, two power supply lines for supplying power to said television set and a protective coating provided to cover said electric signal line and said two power supply lines, wherein
the respective ones of said two power supply lines included in said cable for a television set are arranged on both sides of said electric signal line to hold said electric signal line therebetween, and said protective coating is formed to have a flat outer shape, and
said image signal from said external input unit is transmitted to said television set through said electric signal line of said cable for a television set.

13. The television system according to claim 12, wherein
said protective coating of said cable for a television set is formed to have said flat outer shape corresponding to any of a trapezoidal shape, a rectangular shape, an elliptical shape and such a shape that the thickness of a central portion corresponding to said electric signal line is smaller than the thickness of both end portions corresponding to said two power supply lines.

14. The television system according to claim 12, wherein
said electric signal line of said cable for a television set includes a plurality of electric signal conductors,
said protective coating of said cable for a television set includes a first protective coating covering each of said plurality of electric signal conductors and a second protective coating covering all of said plurality of electric signal conductors each covered with said first protective coating and said two power supply lines, and
said second protective coating is formed to have said flat outer shape.

15. The television system according to claim 12, wherein
said protective coating of said cable for a television set directly covers said two power supply lines and said electric signal line together, and is formed to have said flat outer shape.

16. The television system according to claim 12, wherein
each of said two power supply lines of said cable for a television set has a sectional area larger than the sectional area of each of said plurality of electric signal conductors.

17. The television system according to claim 12, wherein
said cable for a television set includes a first LAN cable or an HDMI cable, and
said image signal from said external input unit is transmitted to said television set through said first LAN cable or said HDMI cable.

18. The television system according to claim 17, wherein
said image signal from said external input unit is transmitted to said television set through said first LAN cable.

19. The television system according to claim 18, further comprising a second LAN cable mounted on said external input unit, wherein
a LAN port for connecting said first LAN cable with said second LAN cable different from said first LAN cable is provided in the vicinity of an end portion of said first LAN cable arranged to be held between the respective ones of said two power supply lines, and
said image signal from said external input unit is transmitted to said television set through said second LAN cable mounted on said external input unit, said LAN port and said first LAN cable.

20. The television system according to claim 12, wherein
said protective coating, having said flat outer shape, of said cable for a television set is semitransparent.
